(19) United States
(12) Patent Application Publication
(10) Pub. No.: US 2013/0328279 A1
(43) Pub. Date: Dec. 12, 2013

(54) Three-in-One Convertible Cart

(71) Applicant: William Kurt Feick, New Canaan, CT (US)

(72) Inventor: William Kurt Feick, New Canaan, CT (US)

(21) Appl. No.: 13/491,805

(22) Filed: Jun. 8, 2012

(51) Int. Cl. B62B 3/02; B62B 3/04; B62B 3/00

(52) U.S. Cl. 280/47.18; 280/47.27

(57) ABSTRACT

An improved convertible cart can be converted from a hand truck to a platform by a simple pull of a spring loaded adjustment arm. The convertible cart has reversible wire retainers. When the edge of the wire retainer is facing upward, it prevents an object being carried from shifting sideways off of the rails. The wire retainers can also be flipped downwards to allow an oversized object to be carried flat and extend outside the retaining rails. The toe plate of the cart can be used as a seat with a pad that can be attached as a weeding pad either from the seated or kneeling position. The cart's handle frame can be sleeves into its base frame so that entire cart can be packed tightly within the tub to allow the tub to be the principal storage and delivery means for display, sale and shipment.

### BACKGROUND OF THE INVENTION

1. Field of the Invention

The present invention relates generally to convertible carts and to improvements in the structural construction and more specifically to convertible carts that can be conveniently converted from a vertical two-wheeled position to a horizontal four-wheeled position with a simple pull of a spring loaded adjustment arm and to providing a gardening seat.

2. Description of Related Art

A vertical hand truck typically includes a toe plate aka support plate or nose plate that is inserted beneath the object to be lifted; once the object is lifted it is tilted against the main frame and rolled to a desired location. This type of device can reduce the labor or risk of injury inherent in lifting a heavy and/or bulky load.

U.S. Pat. No. 3,647,238 to Mackey discloses a hand truck which includes a load support mounted on a wheel and axle assembly, with a handle unit likewise connected to said wheel and axle assembly, both pivotally related, and means to interconnect the said support and handle unit for simultaneous movement, in various adjusted positions so that the hand truck and its load may be manipulated either to maintain the load support at a generally level attitude, or to change the same depending upon the type of load to be carried thereon.

U.S. Pat. No. 3,578,353 to Lockhart discloses a hand truck comprising a vertical frame supported on a pair of support wheels and including a pair of support handles at its upper extremity. The hand truck includes a third wheel carried from the truck frame and extendable to a supporting position.

However, this type of device still puts a lot of weight on an operator if the carried object is very heavy; it may not be easy for an operator to carry the object in an upright position. It may be desirable to convert the vertical hand truck to a horizontal platform type of cart so as to make it easier to carry a bulky and heavy load. A convertible cart that can be converted from a two-wheeled upright hand truck to a four-wheeled horizontal push cart is known in the prior art. More specifically, by way of example, U.S. Pat. No. 3,785,669 to Doheny, discloses a hand truck wherein the hand truck having a pivotable handle mounted near the top of the upright hand truck and having smaller castors attached at the ends thereof may be pivoted relative to the frame in order to bring the handle into an upright position and the wheels into contact with the floor when the hand truck is lowered to a horizontal position.

U.S. Pat. No. 4,921,270 to Schoberg discloses a convertible hand truck including a pivotable handle member which may be stowed or selectively used as an extension of the toe plate when the hand truck is in an upright two-wheeled position, and may serve as the push handle for the hand truck when used in an horizontal four-wheeled position.

Although there are upright hand trucks which can be converted to four-wheeled horizontal push carts available in the marketplace, the present invention can be converted to providing a seat for an operator to sit on or kneel for gardening in addition to using it as a hand truck or push cart. The present invention also provides wire retainers which can be adjusted to prevent the object of different sizes from sliding off laterally from the cart; the wire retainers can be reversed to allow an oversized object to be carried flat and extending outside the retaining rails of the cart.

### SUMMARY OF THE INVENTION

The present invention relates generally to three-in-one convertible carts and to improvements in the structural construction to make a convertible cart: easier to convert from a vertical hand truck mode to a horizontal push cart mode, easier to carry objects of any size, easier to tightly pack within a tub and use tub as a principal means for storage and shipment. The invention allows for a convenient conversion from a vertical hand truck model to a horizontal push cart model with a simple pull of a spring loaded adjustment arm. The current invention includes reversible and adjustable wire retainers that project out from the bed or retaining rails of a cart. When the edge of the wire retainer is facing upward, it prevents an object being carried within it from shifting sideways off of the rails either in the vertical hand truck position or when used in the push cart position, the wire retainers can also be flipped downwards (reversed) to allow an oversized object to be carried flat and extend outside the retaining rails of the hand truck or push cart. The handle frame of the cart can slide into the base frame of the cart so all the parts of the cart can be packed more tightly within the tub to allow the tub to be the principal means to sell the product or send the product through the mail or other delivery means.

A cart with a toe plate and a handle that conform to the shape of a rectilinear tub to keep the tub confined at the ends and with the wire retainers preventing the tub from sliding laterally.

In an exemplary embodiment of the present invention, there is disclosed a convertible cart that can be converted from a vertical hand truck to a 4-wheel push cart and vice versa, the convertible cart comprising a handle frame including a pair of spaced side rails, preferably of round, tubular configuration being spaced one from the other by means of transverse bars; a base frame including a pair of spaced retaining rails, preferably of square, tubular configuration being spaced one from the other by means of transverse bars; a pivotable (rotatable) solid toe plate is pivotally mounted at the lower end of both retaining rails; a pair of braces, a pair of wheels and an axis interconnecting the wheels, the braces are connected to the bottom of the retaining rails at their ends, the axis interconnecting the two braces and the two wheels; a pair of castors or wheels; a plurality of reversible and adjustable wire retainers that project out from the bed or retaining rails of the cart; when the edge of the wire retainer is facing upward, it prevents an object being carried within it from shifting sideways off of the rails either in the vertical hand truck position or when used in the push cart position; a plurality of retaining knobs with screws; a plurality of wire retainer holders that are essentially tubes with nut retainers for holding wire retainers' wires and hold retaining knobs with screws to secure the wire retainers in place; and a spring loaded adjustment arm with spring loaded release mechanism.

The spring loaded release mechanism allows a cart to be converted from a vertical hand truck to a cart with four wheels or two wheels and two castors and vice versa. The wire retainers can also be flipped downwards (reversed) to allow an oversized object to be carried flat and extending outside the retaining rails of the hand truck or push cart. The wire retainer's wire can be adjusted in and out and secured incrementally using knobs and screws to tighten the wire retainers at various widths. The convertible cart further comprises a foam pad with a means to attach to the toe plate which can be stored on the outside of the toe plate when the tub is in place and which can be used as a seat when the toe plate is flopped flat against the rails of the carts or removed to be used as a kneeling pad or can be left in the “seat” position and used from the kneeling position to weed a garden. The tubular handle frame is further divided to a handle section and a lower tubular frame section, the handle section can be inserted into the lower tubular frame section so that the length of the handle section exposed outside the lower tubular frame section can be adjusted to make the handle either shorter or longer to make it ergonomic when used in the vertical hand truck position or used in the horizontal push cart position. The pins are used to hold and secure the handle in place inside the lower tubular frame section. The upper ends of the lower tubular frame section include plastic tube supports (or nylon sleeves) that allow the handle to make an easy sliding adjustment without scratching the steel handle in the adjustment process.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side perspective view of the farm cart with solid toe plate and reversible adjustable wire retainer in a vertical hand truck mode in accordance with the principles of the invention.

FIG. 2 is a side perspective view of the farm cart of FIG. 1 converted to a horizontal push cart mode in accordance with the principles of the invention;

FIG. 3 is a side perspective view of the farm cart of FIG. 1 converted to provide a cushioned seat for gardening where the solid toe plate is covered by a foam pad and canvas bag.

FIG. 4A is a view showing that the handle frame is able to sleeve into the base frame section with capability for tight packing within the tub and FIG. 4B is a view showing all parts of the cart are tightly packed within the tub.

FIG. 5 is a partial side perspective view showing that handle frame has a handle and a lower frame; the handle can be inserted into the lower frame thus the length of the handle exposed outside the lower frame is adjustable; the upper end of the lower frame has a plastic tube support for the handle to slide inside easily without scratching.

FIG. 6 is a perspective view showing that the length of the handle and handle frame is shorter in the vertical hand truck mode, thus it is ergonomic to the user.

FIG. 7 is a perspective view showing that the length of the handle and handle frame is longer in the vertical hand truck mode, thus it is ergonomic to the user.

FIG. 8 is a perspective view of a spring loaded handle release mechanism in one embodiment of the cart according to the principle of the present invention.

FIG. 9 is a perspective view showing how a user pulls the spring loaded lever to convert the cart from a horizontal push cart.

FIG. 10 is a perspective view observed from side bottom of the cart showing the edge of the wire retainer facing upward to prevent an object being carried from shifting sideways off of the rails.

FIG. 11 is a perspective view observed from side bottom of the cart showing the wire can be adjusted at various widths.

FIG. 12 is a perspective view observed from side bottom of the cart showing that the wire retainer is removed from wire retainer holder and reversed.

FIG. 13 is a perspective bottom view of the cart showing that the wire retainers are in a reversed position.

FIG. 14 is a perspective bottom view of the cart showing that the length of the wires can be adjusted.

FIG. 15 is a perspective top view of a canvas bag with a foam pad inside having a sleeve to slide over the toe plate of a cart.

FIG. 16 is a perspective view of a standing up toe plate covered by the foam pad contained canvas bag.

### DESCRIPTION OF THE PREFERRED EMBODIMENT

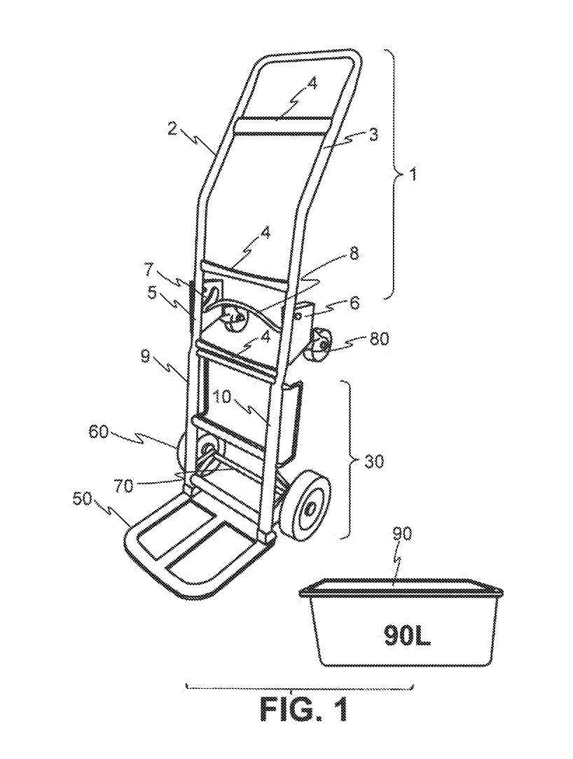

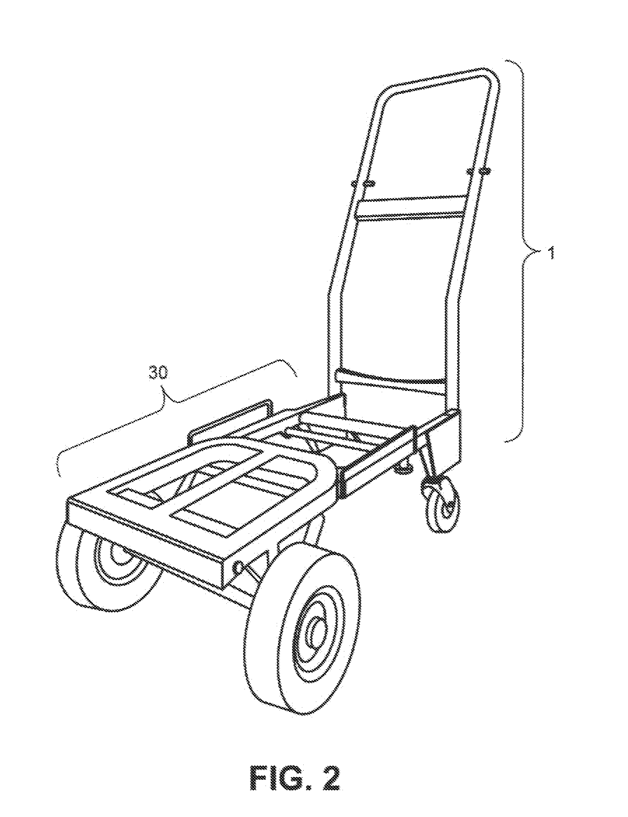

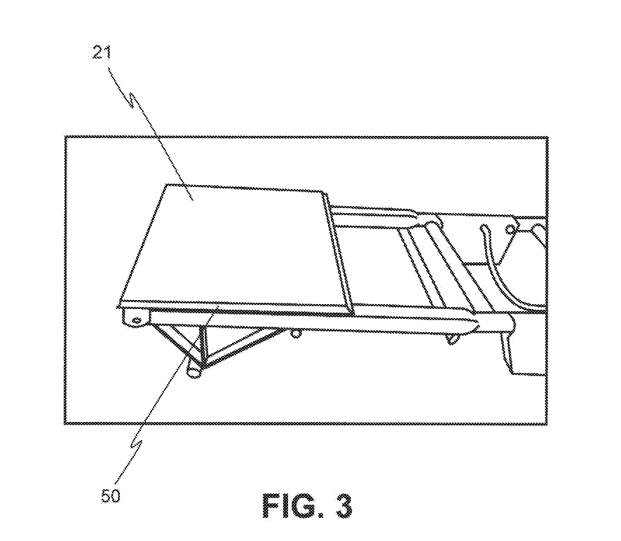

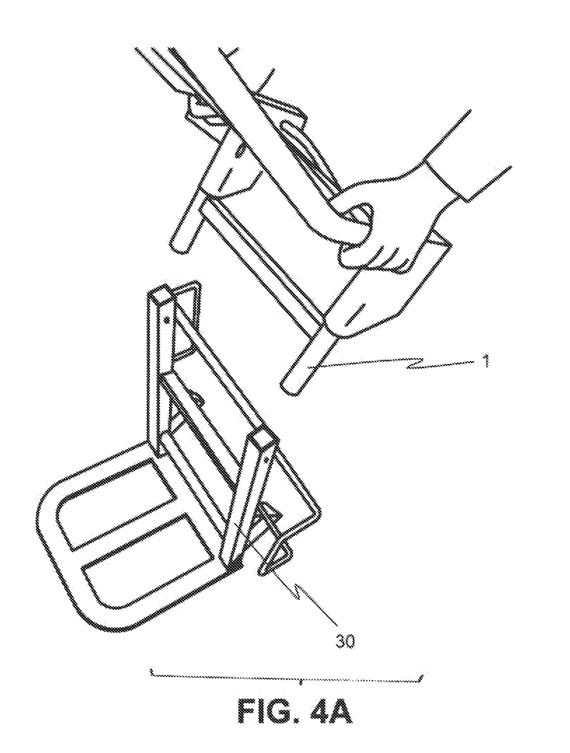

Referring to FIGS. 1-3, there is disclosed a side perspective view of a 3-in-1 convertible farm cart 100 according to one embodiment of the present invention without showing the tub. The convertible cart 100 can be converted from a vertical two-wheeled hand truck as shown in FIG. 1 to a four-wheeled push cart as shown in FIG. 2. It can also be converted to a gardening seat as shown in FIG. 3.

The farm cart 100 from top to bottom comprises a handle frame generally designated 1, a base frame generally designated 30, a toe plate generally designated 50, two wheels 60 and an axis 70, two castors 80, as well as a tub 90.

The handle frame 1 includes a pair of spaced side rails 2, 3 preferably of round, tubular configuration being spaced one from the other by means of transverse bars 4. The base frame 30 also includes a pair of spaced side rails (also called retaining rails) 9, 10, preferably of square, tubular configuration being spaced one from the other by means of transverse bars 4. The toe plate 50 is located at the end of both retaining rails 9, 10 and is preferably a solid continuous sheet that can support a cushion and a human when used as a seat.

The cart 100 further comprises a pair of brackets 5 and 6, each has a slot 7 on the side facing towards each other, are fixedly mounted at the lower extremity of the side rails 2 and 3; and a spring loaded lever 8 of which each end residing inside the slot 7 of each bracket 5, 6. This spring loaded lever 8 when swung (or pulled) will convert the cart 100 from a vertical hand truck as shown in FIG. 1 to a horizontal push cart with 2 wheels and 2 castors as shown in FIG. 2. In the vertical hand truck mode, the base frame 30 is still vertical, while in the platform mode the base frame 30 becomes horizontal. In another embodiment, the farm cart 100 comprises four wheels instead of two wheels and two castors.

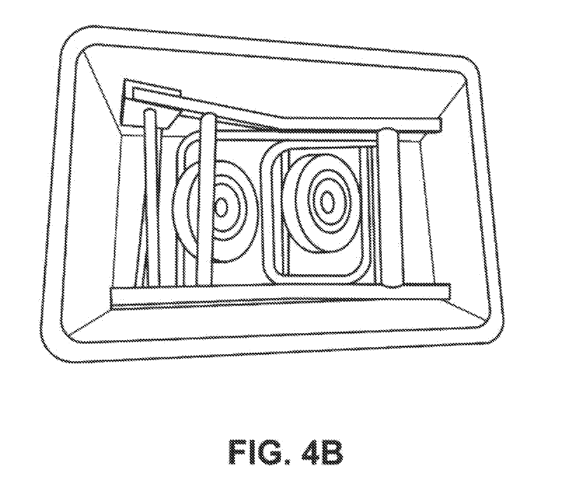

As shown in FIG. 4A, the handle frame 1 can be sleeved into the base frame 30 so the cart 100 can be packed more tightly within the tub 90 to be the principal means to sell the product or send the product through the mail or other delivery means for shipping or storage or display on a shelf as shown in FIG. 4B.

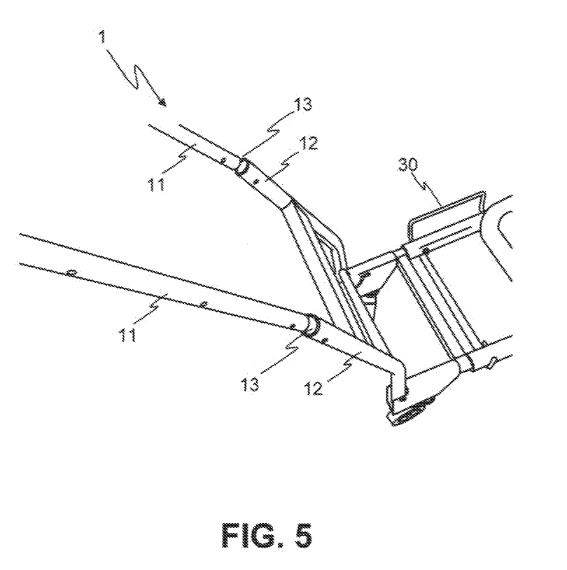

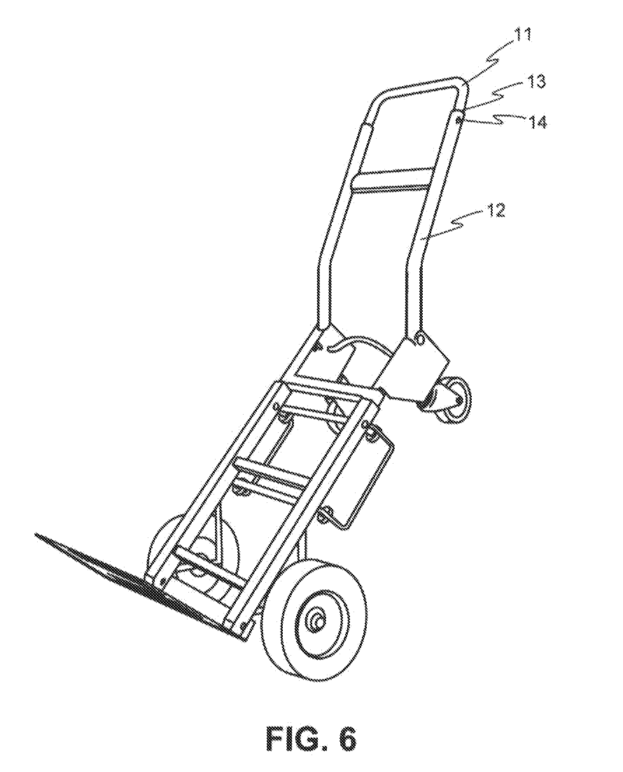

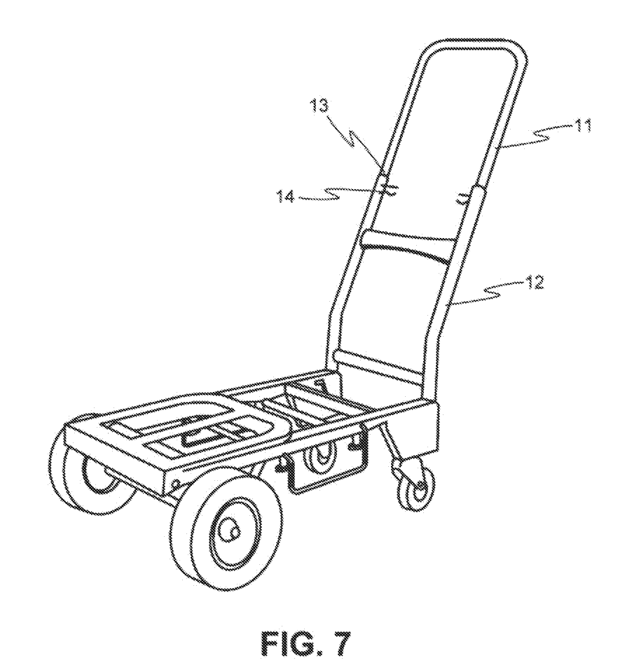

The handle frame 1 can be further separated to handle 11 and lower frame 12. The upper parts of the tubular lower frame 12 have nylon sleeves (plastic tube support) 13 inserted into said tubes 12 for easy sliding of the handle frame (that allow the handle to make a sliding adjustment without scratching the steel handle in the adjustment process) as shown in FIG. 5. Both the handle frame and lower frame are sleeved into one another to assemble together for operation (FIG. 5). A pin 14 is used to hold one side of handle frame in shorter position (FIG. 6) which is ergonomic for using the cart as hand truck or longer position ergonomic to use the cart as a four wheel platform (FIG. 7).

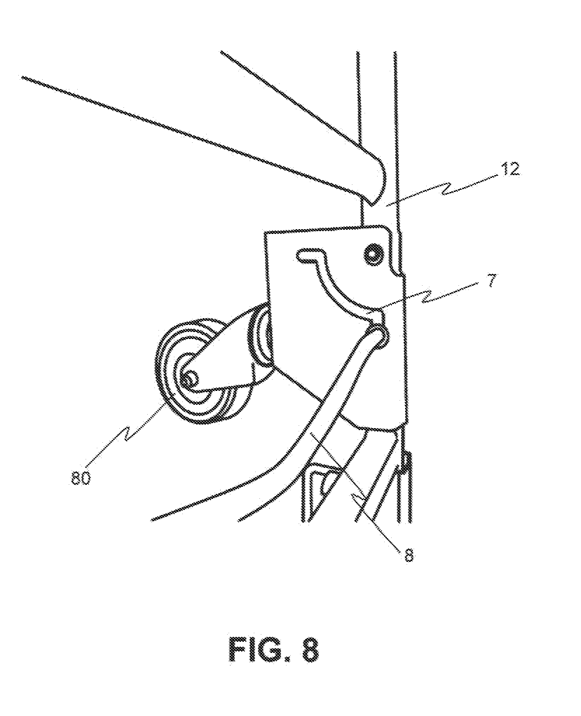

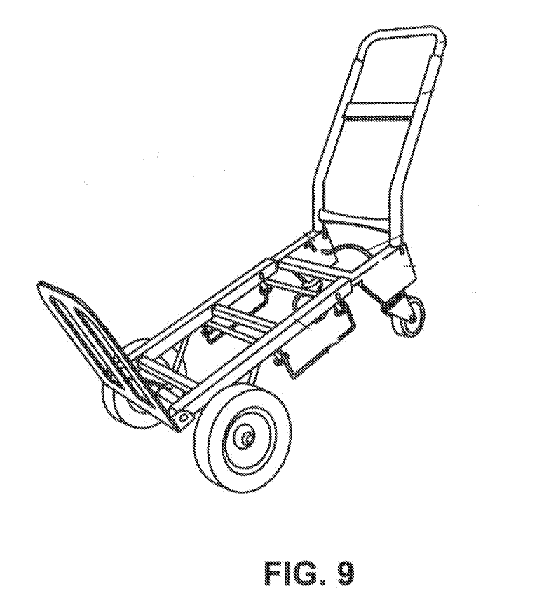

The farm cart 100 comprises a spring loaded release mechanism as shown in FIG. 8 to allow the base frame 30 to be converted from a vertical position as in a hand truck mode to a horizontal position as in a push cart mode and vice versa. For example, in one embodiment, the farm cart comprises an optimal spring loaded transverse lever 8 across the brackets 5, 6 attached on the lower tubular frame 12. With a pull on the spring loaded transverse lever 8 enables a quick switch of the base frame 30 from one position to the other as shown in FIG. 9.

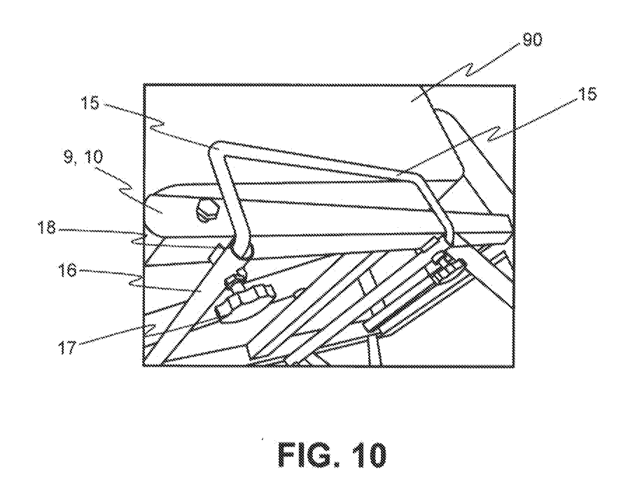

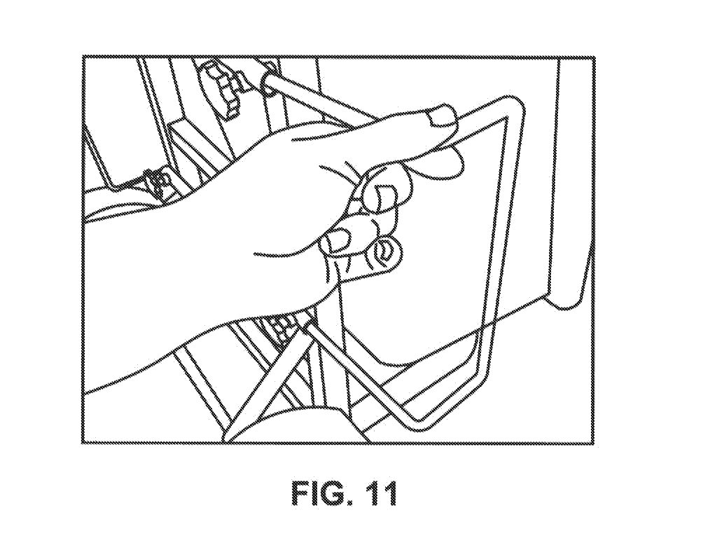

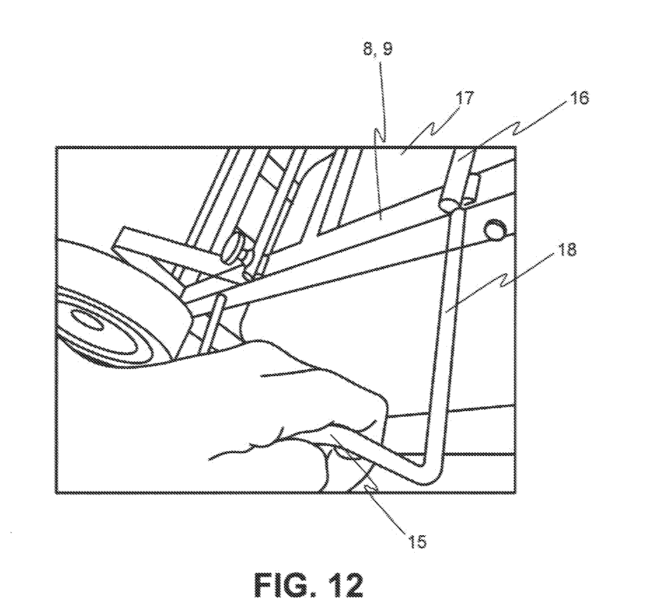

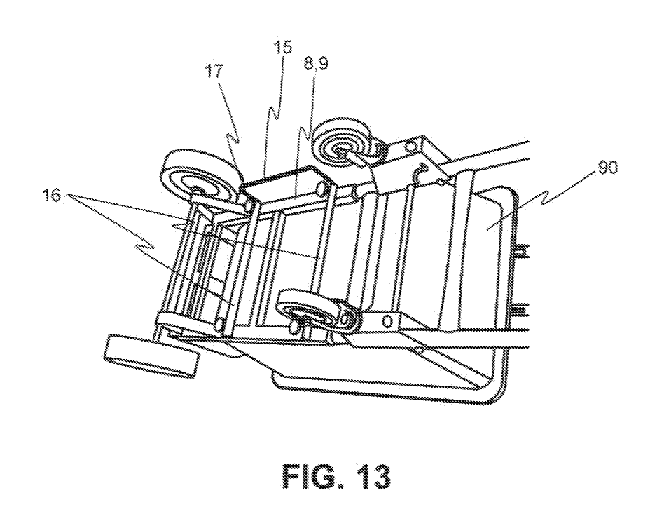

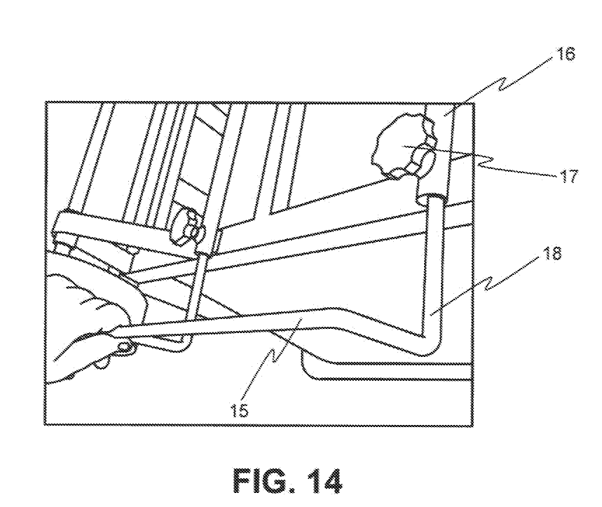

The farm cart 100 further comprises a wire retainer 15 that projects out from the bed or retaining rails 9 and 10 of the cart 100 to prevent an object being carried from shifting sideways off of the rails either in a vertical hand truck position or when used in the converted cart position (FIG. 10). The farm cart 100 further comprises wire retainer holders 16 that are essentially tubes with nut retainers that will hold a knob or screw 17 to secure the wire retainers 15. The wires 18 of the wire retainer 15 can be adjusted in and out and secured incrementally using knobs or screws 17 that tighten the wire retainers at various widths (FIG. 11) to accommodate objects of different sizes. The wire retainer 15 can be removed from the wire retainer holders 16 (FIG. 12) and flipped downwards (reversed) to allow an oversized object to be carried flat and extending outside the retaining rails 9, 10 of the hand truck or cart 100 (FIG. 13). The wires 18 of the wire retainer can be adjusted in and out and secured incrementally using knobs or screws 17 that tighten the wire retainers at various widths (FIG. 14). The two wire 18 restraints are held in TWO wire retainer holders 16 in these pictures. If they are held in FOUR wire retainer holders 16 the length of the wire 18 parts that are inserted within the wire retainer holders 16 can be lengthened.

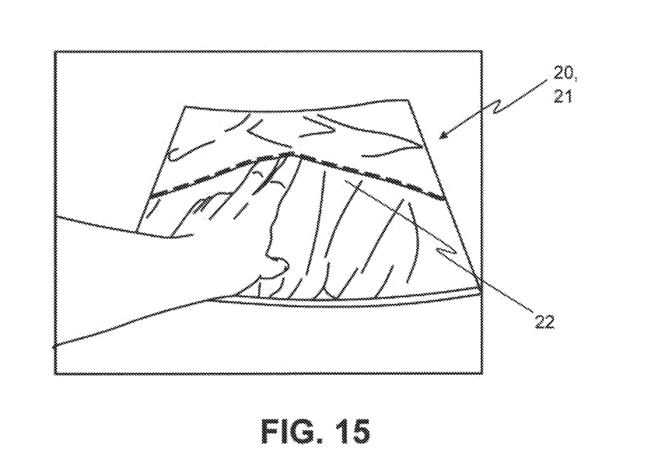

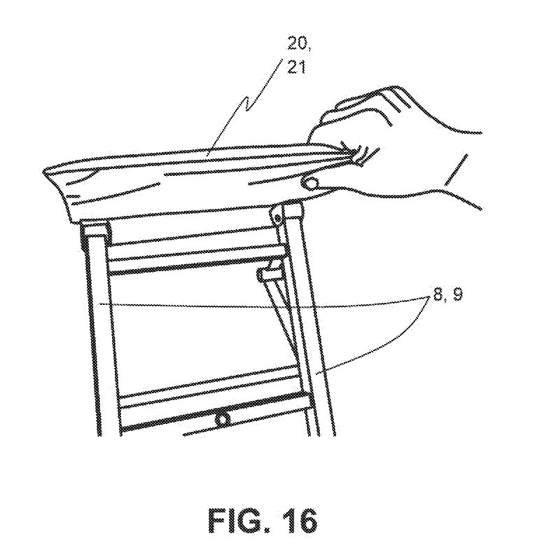

The toe plate 50 extends from the bottom end of the retaining rails 8, 9 can stands up forming a normal angle to support a removable tub 90 or any object (as shown in FIGS. 1 and 2) or swung down flat against rails 8, 9 of the cart 100 to allow a flat object extending off the end of the cart to be carried without impediment as shown in FIG. 7 or can be used as a gardening seat as shown in FIG. 3. In one embodiment, the farm cart 100 further comprises a magnet 19, when the toe plate is swung down flat it can hold the toe plate in place. In one embodiment, the toe plate 50 is a solid plate, without the tub, it can be flopped down pivoting on the securing bolts so the flat plate position can allow someone to sit or kneeling on it to weed a garden or work on a project in the field. The farm cart 100 further comprises a foam pad with a means to attach to the toe plate as a cushion, as a seat alternative (FIG. 3). In one embodiment, the farm cart 100 comprises a foam pad 20 and a canvas bag 21 designed to hold the foam pad 20. The canvas bag 21 has a sleeve 22 (FIG. 15) to slide over the toe plate 50 (FIG. 16), so the foam pad covered by the canvas bag can work as a cushion, as a seat alternative (FIG. 3). Seat or kneeling pad can be used off of the cart as well.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A convertible cart that can be converted from a vertical hand truck to a 4-wheel push cart and vice versa, the convertible cart comprising:
a handle frame including a pair of spaced side rails, preferably of round, tubular configuration being spaced one from the other by means of transverse bars;
a base frame including a pair of spaced retaining rails, preferably of square, tubular configuration being spaced one from the other by means of transverse bars;
a pivotable (rotatable) solid toe plate is pivotally mounted at the lower end of both retaining rails; securing bolts
a pair of braces, a pair of wheels and an axis interconnecting the wheels, the braces are connected to the bottom of the retaining rails at their ends, the axis interconnecting the two braces and the two wheels;
a pair of castors or wheels;
a plurality of reversible and adjustable wire retainers that project out from the bed or retaining rails of the cart when the edge of the wire retainer is facing upward, it prevents an object being carried within it from shifting sideways off of the rails either in the vertical hand truck position or when used in the push cart position;
a plurality of retaining knobs with screws;
a plurality of wire retainer holders that are essentially tubes with nut retainers for holding wire retainers' wires and hold retaining knobs with screws to secure the wire retainers in place; and
a spring loaded adjustment arm with spring loaded release mechanism.

2. The convertible cart of claim 1, wherein the spring loaded adjustment arm is pulled to swing the handle between the upright hand truck and horizontal push cart modes.

3. The convertible cart of claim 2, wherein the spring loaded release mechanism allows a cart to be converted from a vertical hand truck to a cart with 4 wheels or 2 wheels and 2 castors and vice versa.

4. The convertible cart of claim 1 wherein the wire retainers can be flipped downwards (reversed) to allow an oversized object to be carried flat and extending outside the retaining rails of the hand truck or push cart.

5. The convertible cart of claim 4 wherein the wire retainer's wire can be adjusted in and out and secured incrementally using knobs and screws to tighten the wire retainers at various widths.

6. The convertible cart of claim 5 wherein the tubular retaining wire holders can be either two tubes holding both wires or four tubes that allow longer retaining wires with longer width retention.

7. The convertible cart of claim 1 wherein the toe plate extending up and substantially perpendicular to the retaining rails to support a removable tub on the end.

8. The convertible cart of claim 7 further comprising a magnet, wherein the toe plate can be swung flat against the rails of the cart to allow a flat object extending off the end of the cart to be carried without impediment and held in place with the magnet.

9. The convertible cart of claim 8 wherein the toe plate can bear weight for use as a toe plate when used as a hand truck.

10. The convertible cart of claim 9 wherein the toe plate can be flopped down pivoting on the securing bolts so the flat plate position can allow someone to sit on the end of the cart to weed a garden or work on a project in the field with the tub removed.

11. The convertible cart of claim 10 further comprising a foam pad with a means to attach to the toe plate which can be stored on the outside of the toe plate when the tub is in place and which can be used as a seat when the toe plate is flopped flat against the rails of the carts or removed to be used as a kneeling pad or can be left in the “seat” position and used from the kneeling position to weed a garden.

12. The convertible cart of claim 1 further comprising a plurality of pins, wherein the tubular handle frame is further divided to a handle section and a lower tubular frame section, the handle section can be inserted into the lower tubular frame section so that the length of the handle section exposed outside the lower tubular frame section can be adjusted to make the handle either shorter or longer to make it ergonomic when used in the vertical hand truck position or used in the horizontal push cart position, the pins are used to hold and secure the handle in place inside the lower tubular frame section.

13. The convertible cart of claim 12 wherein the upper ends of the lower tubular frame section include plastic tube supports (or nylon sleeves) that allow the handle to make a easy sliding adjustment without scratching the steel handle in the adjustment process.

14. The convertible cart of claim 1 wherein the handle frame and base frame are sleeved into one another so that the cart can be sold disassembled where all of the parts can be packed more tightly within the tub to allow the tub to be the principal means to sell the product or send the product through mail or other delivery means.

15. Means for preventing objects being carried from sliding laterally off of a cart, the means comprising a plurality of reversible and adjustable wire retainers; and a plurality of tubular wire retainer holders for holding and securing the wire retainers; wherein the wire retainers project out from the retaining rails and face upwards to prevent objects being carried from shifting sideways off of the retaining rails and it can be reversed to face down to allow an oversized object to be carried flat and extending outside the retaining rails of the hand truck or push cart.

16. The means of claim 15 wherein the wire retainer width is adjustable to accommodate objects of different sizes and the tubular wire retainer holders may be two or four tubes.

17. A toe plate of a hand truck that can be used as a seat with a pad that can be attached as a weeding pad either from the seated or kneeling position.

18. The cart of claim 1 wherein the toe plate and the handle conforming to the shape of rectilinear tub to keep the tub confined at the ends and the wire retainers preventing the tub from sliding laterally.

19. The cart of claim 1 wherein the handle that conforms to the shape of the rectilinear tub is further angled outward near the top of the tub to provide additional room for a user to push the cart ergonomically in the 4 wheel position with additional clearance from the castors and frame at the rear of the cart.
